(19) United States
(12) Patent Application Publication
(10) Pub. No.: US 2009/0143212 A1
(43) Pub. Date: Jun. 4, 2009

(54) HIGH-STRENGTH HEAVY-METAL OXIDE GLASS FIBERS AND PROCESS OF MAKING

(75) Inventor: Damh C. TRAN, Potomac, MD (US)

Correspondence Address: BROWDY AND NEIMARK, P.L.L.C.;624 NINTH STREET, NW, SUITE 300, WASHINGTON, DC, 20001-5303, US

(73) Assignee: Infrared Focal Systems, Inc., Silver Spring, MD (US)

(21) Appl. No.: 12/209,095

(22) Filed: Sep. 11, 2008

Related U.S. Application Data
(60) Provisional application No. 60/971,483, filed on Sep. 11, 2007.

(51) Int. Cl. C03C 13/04; C03B 37/02

(52) U.S. Cl. 501/37; 65/429

(57) ABSTRACT

An optical fiber according to Tran U.S. Pat. No. 5,274,728 is improved by chemically etching the surface of the GeO₂-based glass perform with an acid solution based on a mixture of HNO₃ and water.

### I. CROSS-REFERENCE TO RELATED APPLICATIONS

The present application claims the benefit of U.S. Provisional Appln. No. 60/971,483, filed Sep. 19, 2007, the entirety of which is incorporated by reference.

### II. BACKGROUND OF THE INVENTION

Laser surgery involving mid-infrared lasers such as Er:YAG laser (2.94 micron emission) and Er:YSGG (2.79 micron emission) has been evolving rapidly. Since human tissues contain water which has the highest absorption coefficient at around 3.0 microns, mid-IR lasers are very efficient in precise cutting and ablating. Examples of laser surgery involving Er:YAG and ER:YSGG lasers are laser dentistry (cavity preparation, carries removal, and root canal procedure), and ophthalmology (cataract and vitreous tissue removal). Presently, the most common fiber delivery system for mid-IR lasers uses a heavy-metal oxide glass fiber, preferably a Germanium Oxide (GeO₂)-based glass optical fiber¹. GeO₂-based fibers, which have good transmission at 2.79 and 2.94 microns, are capable of handling high power and are resistant to attack from humidity.

The method of making GeO₂-based fibers consists of rotating a cladding molten glass inside a metallic mold to form a solid tube, then pouring the core glass melt in the tube cavity to form a glass perform (Danh C. Tran: ‘Heavy metal-oxide glass optical fibers for use in laser medical surgery,’ U.S. Pat. No. 5,274,728 (1993), incorporated herein by reference). The perform is then drawn into fiber. The strength of the drawn fiber depends on the smoothness of the perform surface. Any defects or pits will be carried over to the fiber surface and will degrade its mechanical strength. Although maximum care has been taken in polishing the mold cavity, pits and flaws could still be observed on the fiber surface at the microscopic level.

The surface of the heavy-metal oxide (such as GeO₂) glass perform as cast in highly polished brass mold displays fine defective structure. The nature of the defects includes tiny flaws, scratches, and deposits. The later is induced from the reaction between the hot molten glass and the brass mold. Fibers drawn from such preform display submicron scratches originating from defects seen on the perform surface. The resulting fibers are generally weak and can not be readily bent or coiled. Attempt to polish away the preform surface flaws would not enhance the tensile strength of the fiber. Because the GeO₂-based glass is relatively soft, particles originating from alumina or silicon carbide polishing media are embedded below the glass surface of the preform. This will cause the fiber to break upon multiple bendings.

To optimize the fiber mechanical strength, the fiber surface must be pristine and free of surface or embedded particulates. This can be achieved by chemically etch the perform surface. For fluoride glass, an etching solution containing H₃BO₃ dissolved in HCl was used (Edwin A. Kindler and Danh C. Tran: ‘High-strength fluoride glass fibers and process of making,’ U.S. Pat. No. 4,898,777 (1990)).

### III. DESCRIPTION OF THE INVENTION

There is no prior art teaching the use of a chemical solution to etch away surface defects on GeO₂-based glass. We disclose the use of a unique acid solution based on a mixture of HNO₃ and H₂O to chemically etch the surface of GeO₂-based glass preform to enhance the fiber strength. The HNO₃-water mixture triggers a congruent dissolution of the oxide glass, giving rise to a pristine perform surface, free of particle deposits and submicron flaws. After the etching step, the perform is rinsed in pure water to remove the acid solution, and then washed in alcohol to remove residual water. After drying in air, the preform is drawn into fibers at its softening temperature. The resulting fibers show high mechanical strength and can be easily handle without breakage.

The HNO₃—H₂O mixture is used for etching GeO₂-based glass surface. The volume ratio of acid to water is preferably about 0.1 to 60 parts acid to 100 parts water, more preferably about 0.5 to 40 parts acid to 100 parts water, and most preferably about 1 to 30 parts acid to 100 parts water. Immersion and etching are carried out preferably between 10° and 125° C., and most preferably between 15° and 40° C. High immersion temperature increases the etching rate but decreases control over the uniformity of the preform cross section, while low temperature immersion decreases the etching rate and lengthens the dissolution process.

### IV. EXAMPLES

### Example 1: (Comparative)

The core and cladding glass molar compositions were 43GeO₂-57PbO and 47GeO₂-53PbO, respectively. 20 g of cladding glass and 30 g of core glass were melted in an alumina crucible at 950° C. for 2 hrs. The cladding melt was poured into a brass mold pre-heated at around 360° C. The mold was then rotated at 2,500 rpm until the melt solidified into a glass tube. The molten core glass was subsequently cast inside the tube, forming a preform, 10 mm diam.×100 mm long. The preform was cooled slowly to room temperature to remove residual thermal stress.

The preform was then drawn directly into fibers at 450° C. and was coated on line with polyimide. The draw yielded about 16 m. of 450 micron core and 500 micron clad fiber. The fiber was cut into 8×2 m. long pieces for testing. The strength test was carried out using a tensile strength proof tester which was pre-loaded with a 5 lb load, which is equivalent to 16,429 Psi tensile strength for a 500 micron fiber. The results showed 8 out of the 8 fiber pieces broke during testing.

### Example 2

A heavy-metal oxide fiber preform was prepared identically as in Example 1. After being removed from the mold, the preform was suspended inside a 2,000 cc beaker containing a mixture of 225 cc HNO3 and 750 cc water at room temperature. The beaker was placed on top of a hot plate, and the solution was stirred slowly using a magnetic stirring bar. The preform was removed from the beaker after 20 min. and was rinsed with isopropanol and water. The preform was air dried before being drawn into fibers at 450° C. and was coated on line with polyimide. It was cut into 8×2 m. long pieces for strength measurement using the same procedure as in Example 1. The results showed all 8 pieces survived the test.

### Example 3

8 pieces of fibers, 2 m. long each, were prepared exactly as in Example 2, except that the etching solution contained 150 cc HNO₃ and 750 cc water. The strength measurements showed that all 8 pieces withstood 16,429 Psi.

The forgoing description of the specific embodiments reveal the general nature of the inventions so that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose for description and not limitation.

What is claimed is:

1. A glass fiber according to U.S. Pat. No. 5,274,728 having a surface which is substantially free of flaws, scratches and deposits, and which consequently has good bending strength.

2. The glass fiber of claim 1 formed from a preform which has been etched to make the surface thereof substantially free of tiny flaws, scratches and embedded particulates.

3. The glass fiber of claim 2 wherein the preform has been etched with an etching solution comprising HNO₃.

4. The glass fiber of claim 3 wherein the volume ratio of HNO₃ acid to water is 0.1-60:100.

5. The glass fiber of claim 3 wherein the volume ratio of HNO₃ acid to water is 0.5-40:100.

6. The glass fiber of claim 3 wherein the volume ratio of HNO₃ acid to water is 1-30:100.

7. In an optical fiber for transmitting mid-infrared wavelength laser light in surgical instruments, comprising GeO₂ glass optionally doped with heavier cations and anions, the improvement wherein
said optical fiber has a surface which is substantially free of flaws, scratches and deposits, said surface having been treated with an etching solution comprising HNO₃.

8. A method of improving the surface and bending strength of a glass fiber in accordance with U.S. Pat. No. 5,274,728, comprising
forming a preform according to said patent, etching said preform to improve the smoothness of said preform and render such preform surface pristine and substantially free of surface or embedded particulates, and then drawing said preform to form a glass fiber.

9. The method of claim 8 wherein said etching is carried out in a solution of HNO₃.

10. A method according to claim 9 wherein the ratio of HNO₃ to water is 0.1-60:100.

11. A method according to claim 9 wherein the ratio of HNO₃ to water is 0.5-40:100.

12. A method according to claim 9 wherein the ratio of HNO₃ to water is 1-30:100.

13. The method according to claims 8 wherein the etching is carried out at 10-125° C.

14. The method according to claim 8 wherein the etching is carried out at 15-40° C.
